(19) United States
(12) Patent Application Publication
(10) Pub. No.: US 2007/0053577 A1
(43) Pub. Date: Mar. 8, 2007

(54) Production of test patterns for test inspection

(76) Inventor: Karl Schanz, Heilbronn (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/565,919

(22) PCT Filed: Jul. 7, 2004
(86) PCT No.: PCT/EP04/07441

§ 371 Date: Oct. 23, 2006

(30) Foreign Application Priority Data
Aug. 1, 2003 (DE) 103 35 312.7

(51) Int. Cl. G06K 9/00

(52) U.S. Cl. 382/145

(57) ABSTRACT

A method and an arrangement for a testing of substrates provided with a predetermined pattern, in particular circuit boards with an application of solder paste. In accordance with the invention the actual pattern applied to the substrate by means of a printing or structuring process is optically detected, the optically detected actual pattern is compared with a desired pattern and in dependence on the comparison and taking into account permissible tolerances it is determined to which further process the observed substrate provided with the actual pattern is to be delivered, wherein the optical detection of the actual pattern is effected in the form of digital data with the formation of an actual data set, a desired data set is formatted from control data for the application of the pattern to the substrates, and data processing is carried out to the effect that the desired data set and the actual data set are compared datawise with one another taking into account permissible tolerances.

The present invention relates to a method and an arrangement for the testing of substrates provided with a predetermined pattern, in particular circuit boards having an application of solder paste.

The production of complex circuits on circuit boards, with its ever increasing density of electronic circuits, leads to ever finer structures, such as terminal pads and conductor paths, and demands precise and effective test methods.

A suitable technique for the attainment of high component densities with low assembly costs is surface mounting SMT (Surface Mount Technology), with which the components are applied directly to the surface of the circuit board and soldered, whereby here the density of the terminals of the surface mounted components SMD (Surface Mounted Device) is higher than that with conventional components.

For the mounting of the SMDs usually solder paste is applied by means of a plotter (U.S. Pat. No. 4,572,103) or screen printing onto the circuit board. Thereafter, the components with their terminals are placed on the applied solder paste and taken through a reflow oven. In the reflow oven, the solder paste is melted, whereby it binds with the components. After cooling, the components are firmly attached with the circuit board.

In the case of screen printing, as a rule metal templates or stencils are employed which are provided with openings at those locations at which, after the printing, solder paste should be; present on the circuit board. The openings may be produced by means of different methods such as for example etching free the openings in the metal template, cutting the openings by means of laser, galvanic production of the mask or the exposure of light sensitive layers on a screen and washing out of non-cured locations.

In the case of all methods, the layout of the circuit board should coincide exactly with the openings of the template. Since a secure soldering of components to the circuit board is only ensured there where sufficient solder paste is present, as a rule, directly after the application, the applied solder paste is checked for presence, offset and bridge building. Usually, in the screen printing machine, the layout of the circuit board is detected by means of a CCD camera and oriented in accordance with the template. Here, the software and the camera system are mostly so configured that with the same camera also a so-called post-printing check inspection can be carried out.

So that, in the post-printing check inspection, the image processing is able to recognize good and bad printing, the pattern to be tested, i.e. the desired pattern, must however first be made known to the computer. For this purpose it is possible to teach in structures to be tested in that one or more printed and/or non-printed circuit boards are optically detected. DE 197 28 144 A1 discloses a method in which not the circuit board but the print template of the circuit board is optically detected for teaching in the desired pattern. These test methods are, however, time and cost intensive.

The object on which the invention is based is to indicate a method and an arrangement for the testing of a substrate provided with a predetermined pattern, with which a rapid and nonetheless precise testing is possible.

This object is achieved in accordance with the features of the independent claims. Thus, the actual pattern applied to the substrate by means of a printing or structuring process is optically detected, the optically detected actual pattern is compared with a desired pattern and dependent upon the comparison, and taking into account permissible tolerances, it is decided to which further process the observed substrate having the actual pattern is to be delivered, wherein the optical detection of the actual pattern is effected in the form of digital data with the formation of an actual data set, a desired data set is formatted from control data for the application of the pattern to the substrates, and data processing carried out to the effect that the desired set and the actual data set are compared datawise with one another, taking into account permissible tolerances. A teaching in process is thus not needed. This increases the precision of the testing, since the production of the desired pattern cannot be negatively influenced, as is the case with production by means of teaching in, by factors such as different environmental illumination and/or changes of the surfaces, contaminations and setting errors of the operator. The desired pattern can be produced in a short time for the entire circuit board, wherein the operator solely determines the areas on the circuit board relevant for the testing.

The method is particularly advantageous if the application of the pattern onto the substrates is effected by means of a method employing a correspondingly constituted template, since here the desired data set can be formatted in a very simple manner from the control data already employed for the production of the template.

Further, through appropriate constitution of the data processing, it is possible to subject only certain selected sections of the desired pattern to testing and/or to associate with different sections of the desired pattern different tolerance data subsets. Through this, the data set size necessary for the testing can be reduced and the testing accelerated.

Editing of the respective data sets with regard to the sections to be compared and/or the associated tolerances is possible by means of appropriate constitution of the data processing. Further, archiving is possible and rapid access to the necessary data sets is possible.

The optical detection of the actual pattern can be effected pixel-wise by means of a digital matrix camera, e.g. a CCD camera, whereby for high precision advantageously a one pixel wide linear camera, the length of which corresponds to a linear dimension of the region of the actual pattern on the substrate to be tested, is put to use. For forming a two-dimensional image here, a relative movement between the digital camera and the substrate carrying the actual pattern is carried out with a step width of one pixel, perpendicular to the linear dimension. Whilst the matrix camera is to be moved in part in two dimensions, the linear camera is to be moved step-wise in only one dimension, through which faults, which inevitably arise in mechanical movement, are minimized, which is of significance in the case of very fine structures.

If the substrate on which the actual pattern to be tested is applied itself already carries at least one other pattern, the optical detection is advantageously so configured or effected that it discriminates the actual pattern to be tested with respect to the other pattern and the substrate, for example by means of filtering. Through this, the data set can be reduced, or the resolution of the detected pattern can be increased, already upon detection upon the actual pattern.

The invention is further developed by means of the features of the dependent claims.

Of further advantage, with the use of the desired data set, it can also be tested, expediently regularly, whether the template has during its use been adversely affected to a relevant extent or has otherwise changed and if appropriate whether to initiate a cleaning procedure, a retouching procedure or also, an exchange procedure. The template needs only to be optically scanned in the same manner and the same comparison data processing is to be carried out.

The present invention will be described in more detail with reference to the accompanying drawings, in which there is shown:

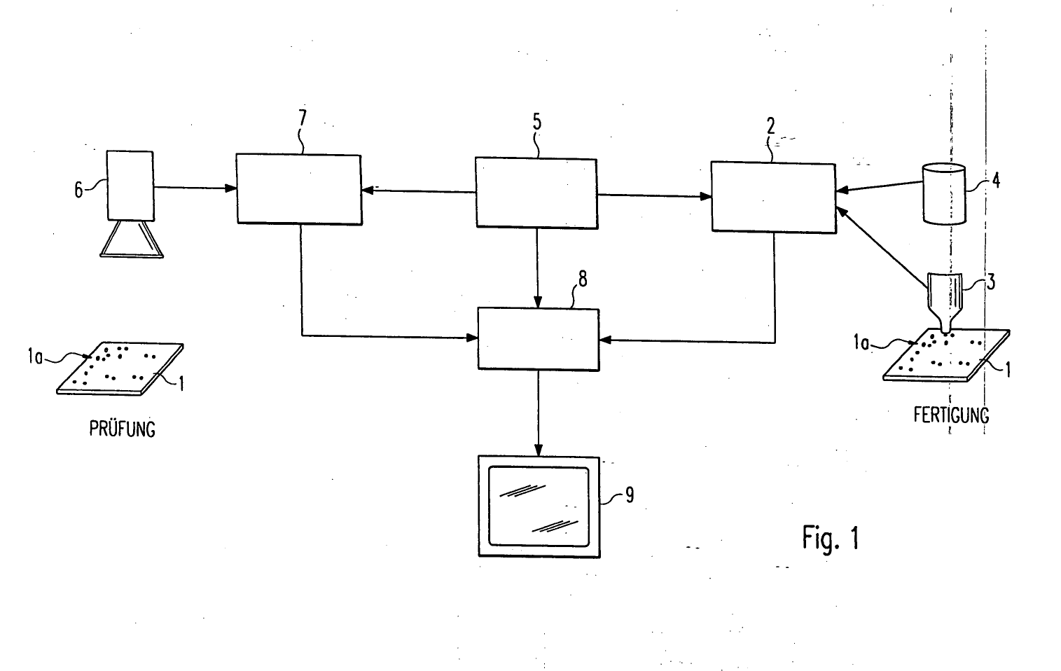

FIG. 1 the basic structure of a first exemplary embodiment for the testing of the pattern applied to a conductor board with solder paste, in accordance with the present invention, and

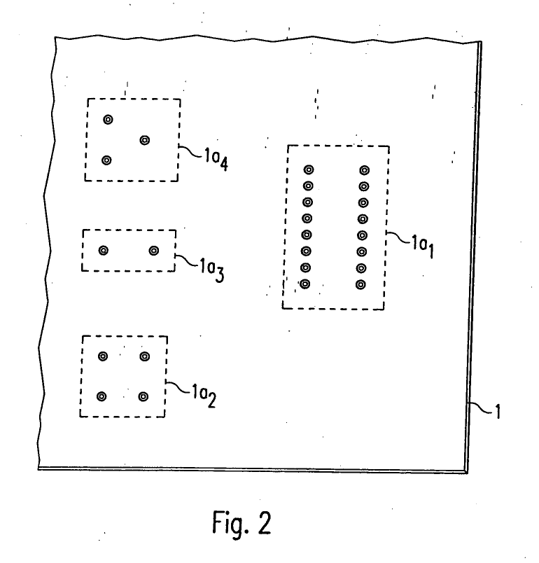

FIG. 2 a sub-division of the pattern applied to the circuit board into sub-patterns in accordance with a second exemplary embodiment of the present invention.

In the example shown in FIG. 1 an actual pattern la, for example a predetermined solder paste pattern, applied to a substrate such as a circuit board 1, is tested in accordance with the present invention. First, control data, by means of which the actual pattern la was generated on the circuit board 1, is delivered to formatting means 2. This control data is obtained, depending on the method of application of the actual pattern 1 a onto the circuit board 1, directly from a plotter 3, which directly applies the actual pattern la, or from a databank 4, which e.g. contains the data for the production of a corresponding print template or the like by means of which the actual pattern la is applied (here not illustrated). The formatting means recognizes the kind of the delivered control data and formats a desired data set from the received control data corresponding to the requirements of a control unit 5. If, as is per se usual, a plurality of circuit boards 1 are to produced with the same actual pattern 1a and tested, the thus produced desired data set is stored, so that the steps of reading in the control data and formatting a desired data set need only to be carried out once in the testing of a plurality of circuit boards 1.

In comparison with the conventional manner of proceeding for the production of desired patterns, in which prototypes for teaching purposes, or a template employed for production, are scanned by means of the camera 6, the faults which necessarily arise in the detection, which is subject to error due to the relative movements, of prototypes which are themselves subject to error, or in the detection, subject to error due to the relative movement, of printing screens which are themselves possibly subject to error (even if to a lesser extent than in the case of prototypes) are here avoided, the data for control of the plotter 3, which is to apply the pattern, or the data for production of a template, such as a printing screen, corresponds fully to the desired pattern and beyond this is also available since it is generated by the developer.

At least the actual pattern 1a of the circuit board 1 patterned with the actual pattern 1a is scanned by a camera 6, which optically detects the actual pattern applied to the circuit board 1 by means of the plotter 3 or the screen printing, in particular in form and pixels, and this is passed on in the form of digital data to a converter 7. The converter 7 converts the actual pattern detected by the camera 6 into an actual data set, corresponding to the requirements of the control unit 5. The actual data set and the desired data set, and a tolerance data set made available by the control unit 5, which describes the permissible tolerances with respect to the desired data set, whereby such tolerances may indeed be different distributed over the desired pattern, are passed on and then delivered to a comparator 8, which taking into account the indicated permissible tolerances in the tolerance data set, compares or correlates datawise the actual data set with the desired data set. The result of the comparison can be shown on a display 9. In particular in the case of an impermissible deviation of the actual pattern from the desired pattern, corresponding sections of the actual pattern can be represented with emphasis on the display 9, in order to make possible for the user an appropriate reaction.

In the case of a continuous automated testing process it may be of advantage both to extract such faulty circuit boards 1 and also to store the associated result of the comparison or the kind and degree of the deviation of the actual pattern from the desired pattern. Further, it is possible on the basis of the comparison to carry out a classification of the quality of the individual circuit boards 1, in particular of the circuit boards 1 classified as faulty, into circuit boards 1 which can be retouched and those which cannot be retouched. Such a classification can e.g. be achieved also by means of different tolerance data sets describing differently long tolerances.

In order to increase precision of the testing, in accordance with the present invention the nature of the actual pattern la on the circuit board 1 is taken into account in the testing in accordance with the invention, in that for example within the overall pattern in regions or sections having higher terminal density, e.g. at the locations where IC components are to be applied to the circuit board 1, a lower tolerance is given with regard to the actual/desired offset than in regions with lower terminal density, e.g. at the locations where resistances and capacitors are to be applied to the circuit board 1. The selection of the regions and the association of the respective tolerances can be effected automatically or by means of the operator.

On the basis of FIG. 2, the automatic selection of the regions and the automatic allocation of tolerances will be explained. FIG. 2 shows a section of a circuit board 1 having a predetermined desired pattern, as is processed by the formatting means 2. As can be recognized, the pattern here has regions 1a₁, 1a₂, 1a₃, 1a₄ having different structures, e.g. densities of applications of solder paste. On the basis of the detected desired data set, which e.g. contains the coordinates, size and form of the individual solder paste applications to be made, the control unit 5 determines or discriminates the regions 1a₁, 1a₂, 1a₃, 1a₄, in that the control unit 5 detects the spacings between the individual points with applied solder paste and assembles points bounding on one another with approximately the same spacings to a region 1a₁, 1a₂, 1a₃, 1a₄. On the basis of the size of the spacings of the points within the corresponding region 1a₁, 1a₂, 1a₃, 1a₄, there are associated with the regions 1a₁, 1a₂, 1a₃, 1a₄ respective permissible tolerances. Thus, data subsets are generated corresponding to the different regions and compared with corresponding data subsets of the actual pattern.

The thus produced desired data sets for each pattern to be tested are edited with regard to the sections to be compared and the associated tolerances and stored. In the testing, the comparator 8 compares datawise the actual data set with the desired data set, taking into account the tolerances determined as permissible for the individual regions 1a₁, 1a₂, 1a₃, 1a₄.

For rapid and effective testing, it may be of advantage to test only section of the desired pattern selected as being considered critical. Such a selection can be effected automatically on the basis of the above described association/determination of tolerances for individual regions 1a₁, 1a₂, 1a₃, 1a₄. Further, only the sections/regions 1a₁, 1a₂, 1a₃, 1a₄ may be subject to a closer testing in a further processing step whose determined permissible tolerances in a first “coarse” processing step are judged as being below a certain value. The control unit 5 discriminates the section to be compared in the actual value data set produced by the converter 7 and brings about the delivery of the selected sections of the actual value and desired value data sets from the converter 7 or the formatting means 2, and from the corresponding tolerance data set, to the comparator 8.

Further, it may be necessary, if the circuit board 1 onto which the pattern to be tested (e.g. of solder paste) is applied, itself already carries another pattern (e.g. a printed circuit) to discriminate the actual pattern la to be tested against this other pattern on the circuit board 1. In accordance with the present invention, for this purpose on the one hand the information is obtained in simple manner from the control data by means of which the actual pattern 1a to be tested was generated on the circuit board 1, wherein on the other hand the camera 6 carries out an optical discrimination of the actual pattern not only with respect to the circuit board 1 but also with respect to this other pattern.

For reducing the data set it is further possible that the control unit 5 so controls the camera 6 or its converter 7 that solely the selected sections of the actual pattern 1a on the circuit 1 are detected.

If the pattern was applied to a substrate such as the circuit board 1, by means of a printing or structuring process using a template, it can arise that in the course of use of the template this so alters, in particular is degraded, that frequently no longer tolerable products are produced with it. It is therefore expedient to check the template for such faults arising in the course of time of use, at the latest upon an increased frequency of non-tolerable products, expediently however earlier and regularly. Advantageously this is effected with the use of the idea on which the invention is based. Since, namely, the desired data set was formatted from the control data employed for producing the template, there suffices an optical scanning of the template corresponding to the optical scanning of the circuit board 1 or the substrate, and the comparison of the so obtained actual data set of the template with the desired data set, in order to detect changes in the template and also to be able to evaluate them, in order at the appropriate time to be able to act through cleaning, retouching and/or exchange. The frequency of the testing of the template depends upon the tolerable deviations in the production of substrates or circuit boards 1. If the tolerances determined in the tolerance data set permit only slight deviations from the desired printing pattern determined in the desired data set, the testing of the template is correspondingly more frequently to be carried out, in the worst case after every individual use of the template for printing or structuring of a substrate such as a circuit board 1. This can be determined by the user and can also be changed.

The optical detection of the actual pattern 1a can be effected pixel-wise by means of a digital matrix camera, a one pixel wide CCD linear camera or line camera, the length of which corresponds to a linear dimension of the region of the actual pattern to be tested on the substrate, or by means of linear sub-cameras arranged in a staggered manner.

The advantage of a line camera with respect to a matrix camera consists in that exposure parameters such as the illumination time and the spacing of the scan lines to one another can be selected for each exposure arbitrarily. For the formation of a two dimensional image, in accordance with the present invention, there is carried out a relative movement between the digital camera and the substrate—circuit board 1—carrying the actual pattern 1a with a step width of one pixel perpendicularly to the one linear dimension. In the exposure, all image points of the CCD line are simultaneously illuminated and after completion of the illumination time all image points are intermediately stored in parallel in a transfer register. This procedure happens very rapidly, so that directly after expiry of one illumination cycle the next begins. From the transfer register, the information is read out image point for image point in series and delivered to the converter 7. Fundamentally, the resolution of the line in the line direction depends upon the number of image points of the camera 6 which are present. The resolution can however be increased by the arrangement of a plurality of cameras next to one another. A further advantage consists in that a mechanically based relative movement takes place in only one dimension, whilst with a matrix camera a relative movement takes place in two dimensions, any mechanically caused relative movement being fundamentally subject to error, which in the case of fine structures can essentially influence the precision of testing.

The present invention is not restricted to the described application for the testing of circuit boards but can rather be applied advantageously anywhere where the patterning/structuring/patterning of parts with a predetermined pattern is to be tested. In the described examples the tolerance data sets for the comparison of the desired data set with the actual data set are delivered to the comparator 8. It is however also possible that already in the formatting of the desired data set and/or in the formation of the actual data set the permissible tolerances are to be taken into account.

1. Method for the testing of substrates provided with a predetermined pattern, comprising
optically defining an actual pattern, applied to a substrate by a printing or structuring process,
comparing the optically detected actual pattern with a desired pattern,
in dependence upon the comparison and taking into account permissible tolerances, determining a further process to which the observed substrate provided with the actual pattern is to be delivered,
effecting the optical detection of the actual pattern in the form of digital data and forming an actual data set,
formatting a desired data set from control data for the application of the pattern onto the substrates, and
carrying out data processing by comparing the desired data set and the actual data set datawise with one another taking into account permissible tolerances.

2. Method according to claim 1,
comprising applying the pattern onto the substrates by a process employing a correspondingly constituted template, and
formatting the desired data set from the control data employed for producing the template.

3. Method according to claim 1, comprising
testing selected sections of the desired pattern.

4. Method according to claim 1, comprising associating
different tolerance data subsets with various sections of the desired pattern.

5. Method according to claim 1 comprising carrying out
data processing by editing the respective data sets with regard to the sections to be compared.

6. Method according to claim 1 comprising effecting
the optical detection pixel-wise by means of a digital camera.

7. Method according to claim 6,
comprising effecting relative movement between the digital camera and the substrate carrying the actual pattern for optical detection.

8. Method according to claim 7, wherein
the digital camera is a linear camera one pixel wide, the length of which corresponds to one linear dimension of the region of the actual pattern on the substrate to be tested, and comprising effecting the relative movement with a step size of one pixel perpendicularly to the one linear dimension.

9. Method according to claim 8, wherein
the linear camera of comprises linear sub-cameras arranged in a staggered manner.

10. Method according to claim 1 wherein
the substrate, on which the actual pattern to be tested is applied, itself already carries at least one other patterns and comprising constituting or carrying out the optical detection so that it discriminates the actual pattern to be tested with respect to the other pattern and the substrate.

11. Arrangement for the testing of substrates provided with a predetermined pattern, comprising
an opto-electronic arrangement for detecting an actual pattern applied to the substrate by a printing or structuring process,
a comparator for comparing the optically detected actual pattern with a desired pattern and in dependence upon the comparison and taking into account permissible tolerances determining a further process to which the observed substrate provided with the actual pattern is to be delivered,
a converter for converting the pattern detected by the opto-electronic arrangement into an actual data set in the form of digital data, and
a formatter to format a desired data set from control data for the application of the pattern onto the substrates, wherein
the comparator carrying out the desired data set and the actual data set datawise with one another taking into account permissible tolerances.

12. Arrangement according to claim 11,
a correspondingly constituted template for applying the pattern onto the substrates.

13-15. (canceled)

16. Arrangement according to claim 11, comprising a digital camera for effecting the optical detection pixel-wise.

17. Arrangement according to claim 16,
the digital camera can move relative to the substrate carrying the actual pattern for optical detection.

18. Arrangement according to claim 17, wherein
the digital camera is a linear camera one pixel wide, the length of which corresponds to one linear dimension of the region of the actual pattern on the substrate to be tested, and the relative movement can be effected with a step size of one pixel perpendicularly to the one linear dimension.

19. Arrangement according to claim 18, wherein
the linear camera comprising linear sub-cameras arranged in a staggered manner.

20. Arrangement according to claim 11, wherein
the substrate, on which the actual pattern to be tested is applied, itself already carries at least one other pattern and the optical detection can be so constituted or so carried out that it discriminates the actual pattern to be tested with respect to the other pattern and the substrate.

21. Method according to claim 2 comprising testing the template for faults arising in the course of use.

22. Method according to claim 4, comprising carrying out data processing by editing the respective data sets with regard to the associated tolerances.
